(19) United States
(12) Patent Application Publication
(10) Pub. No.: US 2007/0268642 A1
(43) Pub. Date: Nov. 22, 2007

(54) Integrated programmable over-current protection circuit for optical transmitters

(76) Inventors: Olivier Metayer, Le cannet (FR); Joseph Duigan, Peymeinade (FR); Jean-Yves Michel, Vallauris (FR)

Correspondence Address: FENWICK & WEST LLP, SILICON VALLEY CENTER, 801 CALIFORNIA STREET, MOUNTAIN VIEW, CA, 94041, US

(21) Appl. No.: 11/435,696

(22) Filed: May 16, 2006

(51) Int. Cl. H02H 3/08

(52) U.S. Cl. 361/93.1

(57) ABSTRACT

An over-current protection circuit shuts off current to an optical transmitter, such as a laser diode, if a detected current to the optical transmitter exceeds a threshold. A circuit element functions to both detect the current and switch off the current if the detected current exceeds a threshold. The circuit element may be a PMOS transistor.

### FIELD OF THE INVENTION

The present invention relates to current protection circuits, and more particularly to over-current protection circuits for optical transmitters.

### BACKGROUND OF THE INVENTION

The laser diode is a very costly and a very performance sensitive part in a transmit optical sub assembly (TOSA). Therefore, protection circuits are integrated in optical transceivers to increase the lifetime of the TOSA and increase the reliability of a system, including the TOSA. Protection circuits typically include an external resistor or an on-chip resistor that provides a voltage proportional to the forward current in the laser diode for monitoring the laser diode current. Using this monitoring, the protection circuit reduces a bias current and a modulation current of the laser driver if an over-current is detected.

### SUMMARY OF THE INVENTION

An over-current protection circuit controls drive current to an optical transmitter, such as a laser diode. The protection circuit includes a circuit element that detects a drive current to the optical transmitter in a first state and blocks the drive current to the optical transmitter in a second state. A control circuit set the first state for detecting the drive current in response to the drive current being below a threshold. The control circuit also sets the second state to block the drive current in response to the drive current being above the threshold. The threshold defines an over-current operation of the optical transmitter. The threshold may be programmable for providing different thresholds based on the type or characteristics of the optical transmitter.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teaching of the present invention can be readily understood by considering the following detailed description in conjunction with the accompanying drawings.

FIG. 1 is a schematic diagram illustrating a first embodiment of a transmit optical system including a integrated programmable over-current protection circuit according to the present invention.

FIG. 2 is a schematic diagram of a reset circuit of the transmit optical system of FIG. 1 according to the present invention.

FIG. 3 is a timing diagram illustrating the operation of the transmit optical system of FIG. 1 according to the present invention.

FIG. 4 is a schematic diagram illustrating a second embodiment of a transmit optical system according to the present invention.

FIG. 5 is a schematic diagram illustrating a third embodiment of a transmit optical system according to the present invention.

### DETAILED DESCRIPTION

A preferred embodiment of the present invention is now described with reference to the figures where like reference numbers indicate identical or functionally similar elements. Also in the figures, the left most digits of each reference number corresponds to the figure in which the reference number is first used.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

An over-current protection circuit shuts off current to an optical transmitter, such as a laser diode, if a detected current to the optical transmitter exceeds a threshold. A circuit element functions to both detect the current and switch off the current if the detected current exceeds a threshold. In one embodiment, the circuit element is a MOS transistor.

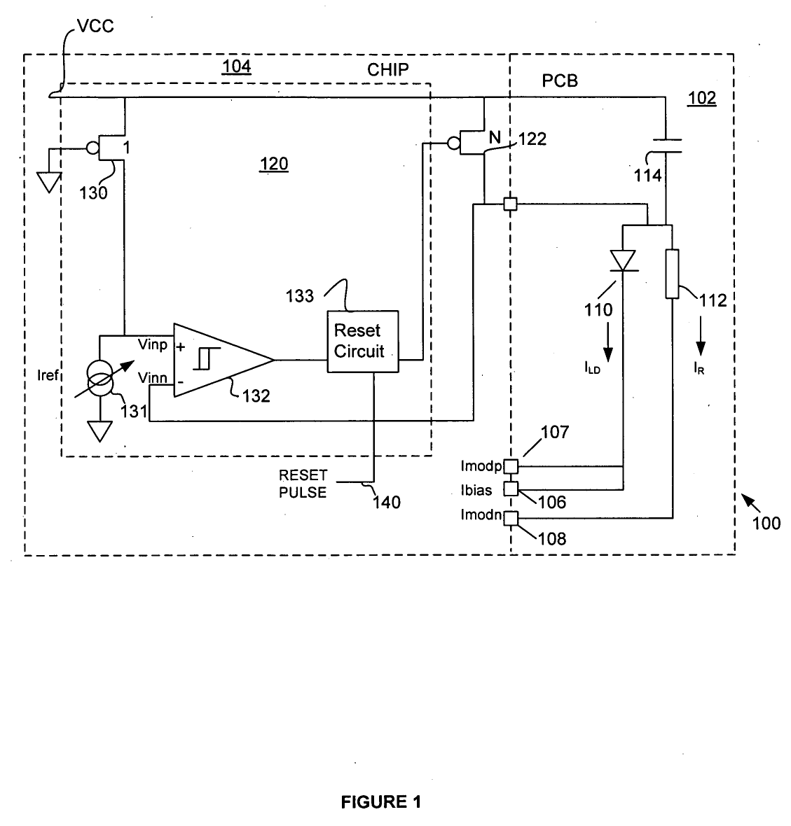

FIG. 1 is a schematic diagram of a transmit optical system 100. The transmit optical system 100 comprises a transmit optical subassembly 102 and an over-current protection circuit 104. In one embodiment, the transmit optical subassembly 102 is disposed on a printed circuit board (PCB), and the over-current protection circuit 104 is disposed in a chip. The transmit optical subassembly 102 generates an optical transmit signal in response to a bias current (Ibias) and a positive modulation current (Imodp) 107, and sinks a negative modulation current (Imodn) 108. The over-current protection circuit 104 provides over-current protection to the transmit optical subassembly 102 to prevent laser damage from, for example, a short on a pin, such as a pin providing one of the currents 106, 107, and 108.

The transmit optical subassembly 102 comprises a laser diode 110 and a resistive element 112. The bias current (Ibias) 106 provides a fixed bias current to the laser diode 110 to set an operating point. The positive modulation current (Imodp) 107 modulates the bias current to modulate the optical output of the laser diode 110 for transmitting data. The negative modulation current (Imodn) 108 sinks current in the resistive element 112 when the laser diode 110 is not modulated. In another embodiment, the transmit optical sub-assembly 102 does not include the resistive element 112. In this case, any negative modulation current may be sunk elsewhere.

The over-current protection circuit 104 comprises a control circuit 120 and a switch 122. In one embodiment, the switch 122 is a PMOS transistor and is referred to hereinafter as PMOS transistor 122. The PMOS transistor 122 measures and controls the current through the laser diode 110, and shuts off the current flow through the laser diode 110 in response to the control circuit 120. The control circuit 120 monitors the current through the PMOS transistor 122 and supplies a control signal to the PMOS transistor 122 to control current flow therein or to disable the PMOS transistor 122 to shut off current to the laser diode 110.

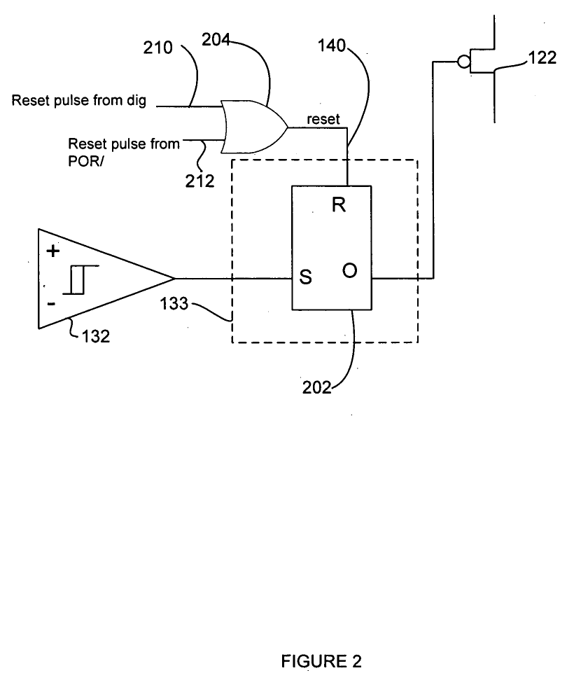

The control circuit 120 comprises a PMOS transistor 130, a programmable current source 131, a comparator 132, and a reset circuit 133. One embodiment of the reset circuit 133 is shown in FIG. 2. In one embodiment, the current source 131 is not programmable. The PMOS transistor 130 and the programmable current source (Iref) 131 generate a reference voltage (Vinp) that sets a threshold current for the over-current protection to a positive input of the comparator 132. The comparator 132 generates a set signal in response to the reference voltage (Vinp) being greater than a detected voltage (Vinn) generated by the laser current flowing into the PMOS transistor 122, and applies the set signal to a set input of the latch 133. A reset signal 140 resets the latch 133. In one embodiment shown in FIG. 2, the reset signal 140 is a combination of a startup pulse 212 and a reset pulse 210 from a digital circuit (not shown). In one embodiment, the PMOS transistor 122 is N times larger than the PMOS transistor 130. If the laser current in the PMOS transistor 122 is N times or greater than the reference current Iref, the comparator 132 sets the latch 133, which in turn shuts off the PMOS transistor 122. The current threshold for the laser diode 110 may be adjusted by modifying the ratio (represented by the number N) between the PMOS transistors 130 and 122 or by changing the reference current Iref. In one embodiment, the number N is in a range of about 10 to about 200. In another embodiment, the number N is about 170. In one embodiment, the PMOS transistor 122 comprises a number N PMOS transistors substantially similar to the PMOS transistor 130 coupled in parallel.

In one embodiment, the transmit optical subassembly 102 may include a filter 114 to reduce ringing on the anode of the laser diode 110. In one embodiment, the filter 114 comprises a capacitor.

The bandwidth of the over-current protection circuit 102 should be sufficiently large to provide fast over-current protection for the laser diode 110. In one embodiment, the bandwidth provides a reaction time less than 30 nanoseconds for a fast change in the average current.

In one embodiment, the current threshold is adjustable from a few milliamps to amps, to cover various laser diode maximum ratings.

The over-current protection circuit 104 automatically compensates for process, supply and temperature variations because both PMOS transistors 122 and 130 track each other across these variations.

FIG. 2 is a schematic diagram of one embodiment of the reset circuit 133. The reset circuit 133 comprises a latch 202 that disables the over-current protection circuit 102 to thereby disable the PMOS transistor 122 until a reset signal 210′ from a digital circuit (not shown) indicates the transmit optical system 100 is ready for operation, or a startup pulse 212 from a power on reset circuit (not shown) indicates power is sufficient for operation. The reset signal 140 resets the reset/set latch 202 after a startup pulse to enable the PMOS transistor 122 and thus turn on current in the laser diode 110. The reset/set latch 202 is reset in response to an OR gate 204 providing an output indicative of a digital reset pulse being sent or the digital circuits being operational as indicated by the reset signals 210 and 212, respectively.

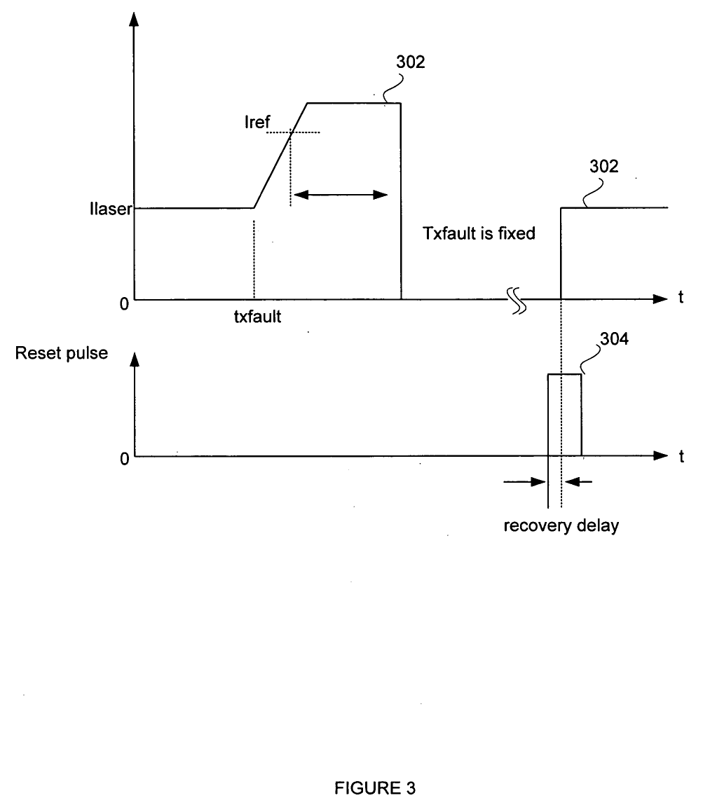

FIG. 3 is a timing diagram illustrating the operation of the over-current protection circuit 104. The top timing diagram includes a line 302 that is the current (I_{ld}) through the laser diode 110. The bottom diagram includes a line 304 of the timing of the reset signal 140. The laser current is substantially constant at a current level Iₗₐₛₑᵣ until a transmitter fault occurs (shown as a time txfault). After the fault occurs, the laser current rises and exceeds a current level that is greater than the threshold level set by the reference current (I_{ref}). After exceeding the threshold, the control circuit 120 disables the PMOS transistor 122, and the laser current drops to zero. A response time of 35 nanoseconds is shown in FIG. 3. When the laser current exceeds the reference current, the comparator 132 applies a signal to the latch 133 to generate a control signal that is high for turning off the PMOS transistor 122. The response time of the over-current protection circuit 104 includes the delay time of the comparator 132, the latch 133, and the PMOS transistor 122. If the transmit fault is fixed, the reset signal 140 shown by the line 304 rising to then reset the latch 133. The comparator 132 generates a set signal because the reference voltage Vinp is above (with respect to a supply voltage VCC) the negative voltage Vinn generated by the laser current Iₗₐₛₑᵣ of the laser diode 110 flowing into the enabled PMOS transistor 122. Because the control circuit 120 is in a first state after a delay (shown as a recovery delay in FIG. 3), the laser current rises to the laser current Iₗₐₛₑᵣ and the reset pulse 140 can go down to zero (shown with the line 304 in FIG. 3).

The operation of the over-current protection circuit level 102 is now described. A voltage ΔVₓ across the PMOS transistor 130 is described by equation 1:

ΔV_{X}=R_{X}×Iref (1).

where R_{X} is the resistance of the PMOS transistor 130 and the current Iref is the reference current generated by the programmable current source 131. The voltage ΔV_{Y} across the PMOS transistor 122 is defined by equation 2:

ΔV_{Y}=R_{Y}×(I_{LD}+I_{R}) (2)

where R_{Y} is the resistance of the PMOS transistor 122, the laser diode current I_{LD} is the current through the laser diode 110 and the resistor current I_{R} is the current through the resistance element 112.

Because R_{X}=N×R_{Y} then when the positive voltage Vinp equals the negative voltage Vinn once (Vinp=Vinn) the trip point of the comparator 132 is reached and the relationship of currents is shown in equation (3):

N×R_{Y}×Iref=R_{y}×(I_{LD}+I_{R}) (3)

Therefore the relationship of currents may be further defined without resistance, if the PMOS transistors 122 and 130 are appropriately sized, by equation (4):

N×Iref=(I_{LD}+I_{R}) (4).

Because the positive modulation current Iₘₒp and the negative modulation current I_{modn} (also described as the reference current Iref) are in opposite phase, the absolute values of the positive and negative modulation currents are equal (|Imodp|=|Imodn|). Therefore, the over-current protection circuit 102 measures the maximum current flowing through the laser diode 110 without any signal modulation on the drain of the PMOS transistor 122.

The programmable current Iref may be set so that the trip point of the comparator 132 is set with respect to the laser diode maximum current.

In one embodiment, the control circuit 120 is formed of a BiCMOS process with the comparator 132 formed using bipolar junction transistors. The reaction time of the loop may be less than 20 nanoseconds.

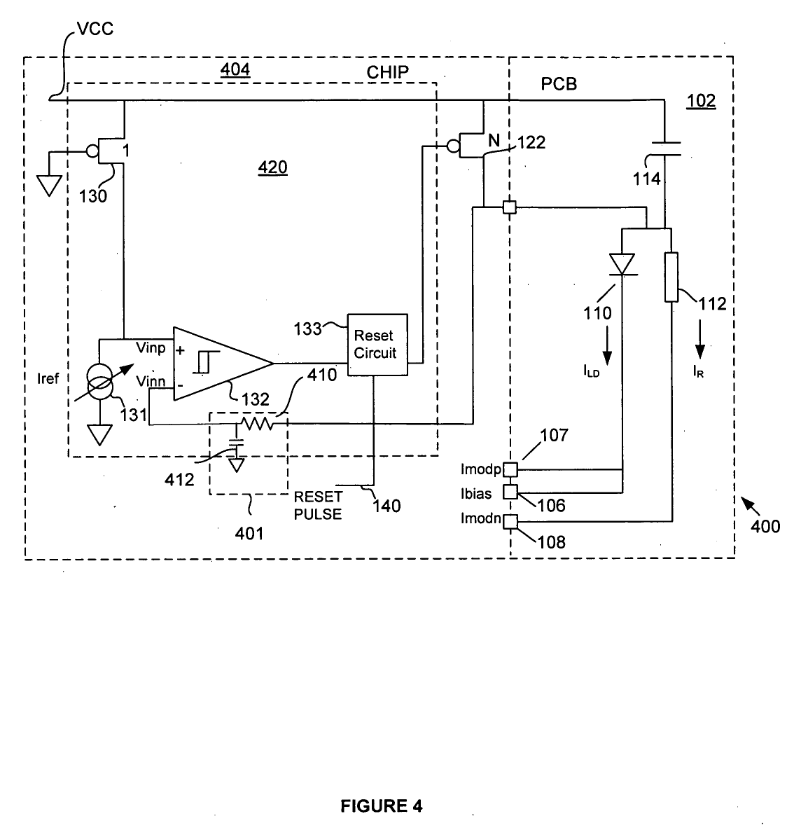

FIG. 4 is a schematic diagram illustrating a second embodiment of the transmit optical system. The transmit optical system 400 of FIG. 4 is similar to the transmit optical system 100 of FIG. 1. An over-current protection circuit 404 and a control circuit 420 are similar to the over-current protection circuit 104 and the control circuit 220, respectively, but the control circuit 420 further includes a filter 401 coupled between the drain of the PMOS transistor 122 and the negative input of the comparator 132 to filter the feedback from the PMOS transistor 122 to the comparator 132. The filter 401 filters the measured signal to reduce noise problems to account for only the DC current. The filter 401 may slow down the response time of the control circuit 120. Thus, the amount of filtering is selected based on desired response time. In one embodiment, the filter 401 comprises a resister 410 coupled between the drain of the PMOS transistor 122 and the negative input of the comparator 132, and comprises a capacitor 412 coupled between the negative input of the comparator 132 and ground.

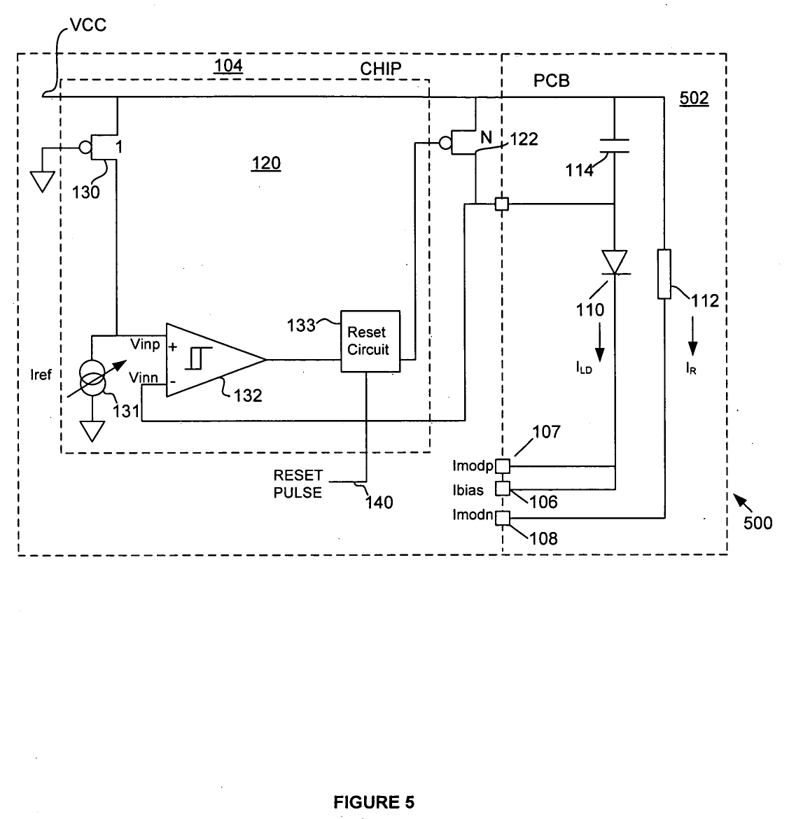

FIG. 5 is a schematic diagram illustrating a third embodiment of the transmit optical system. A transmit optical system 500 is similar to the transmit optical system 100, and includes a transmit optical subassembly 502 that is similar to the transmit optical subassembly 102. The transmit optical subassembly 502 separates the laser diode 110 and the resistive element 112. Although the present invention is described as measuring the maximum current in the laser diode 110, the current may be measured in other ways as shown in FIG. 5. The voltage Vinn gives the instantaneous value of the laser current flowing into the PMOS transistor 122 (e.g., the positive modulation current Imodp+the bias currentIbias) but it exhibits signal modulation at the anode of the laser diode 110.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. An over-current protection circuit for controlling drive current in an optical transmitter, the circuit comprising:
a circuit element including a first terminal for detecting a drive current to an optical transmitter in a first state and blocking the drive current in a second state; and
a control circuit coupled to the circuit element to set the first state in response to the detected drive current being below a threshold and to set the second state in response to the detected drive current being above the threshold.

2. The over-current protection circuit of claim 1, wherein the circuit element comprises a first PMOS transistor including a drain terminal for coupling to the optical transmitter and including a gate for controlling said drive current,
wherein the control circuit comprises:
a reference current generator, and
a comparator including a first input terminal coupled to the reference current generator, including a second input terminal coupled to the drain terminal of the first PMOS transistor and including an output coupled to the gate of the first PMOS transistor to provide a control signal to set the first and second states.

3. The over-current protection circuit of claim 2 further comprising a latch coupled between the output of the comparator and the gate of the first PMOS transistor, the latch setting the first and second states in response to the control signal.

4. The over-current protection circuit of claim 3 wherein the latch is reset in response to a reset signal to set the first PMOS transistor in the first state.

5. The over-current protection circuit of claim 2 wherein the reference current generator comprises:
a current source including a first terminal coupled to the first input terminal of the comparator and including a second terminal coupled to a ground terminal; and
a second PMOS transistor including a source terminal coupled to a source terminal of the first PMOS transistor, including a drain terminal coupled to the first terminal of the current source, and including a gate coupled to the ground terminal.

6. The over-current protection circuit of claim 5 wherein the second PMOS transistor is scaled a number N times the first PMOS transistor, the number N setting the threshold.

7. The over-current protection circuit of claim 5 wherein the first PMOS transistor comprises a plurality of third PMOS transistors, each third PMOS transistor being substantially identical to the second PMOS transistor.

8. The over-current protection circuit of claim 2 further comprising a filter coupled between the drain terminal and a source terminal of the first PMOS transistor.

9. The over-current protection circuit of claim 2 further comprising a filter coupled between the drain terminal of the first PMOS transistor and the second input terminal of the comparator.

10. The over-current protection circuit of claim 9 wherein the filter comprises a resistor including a first terminal coupled to the drain of the first PMOS transistor and including a second terminal coupled to the second terminal of the comparator, and further comprises a capacitor including a first terminal coupled to the second terminal of the resistor and including a second terminal coupled to a ground terminal.

11. The over-protection circuit of claim 2 wherein the reference current generator is programmable to set a reference current.

12. The over-protection circuit of claim 11 wherein the programmable current is set based on the type of optical transmitter.
